(19) United States
(12) Patent Application Publication
(10) Pub. No.: US 2008/0284897 A1
(43) Pub. Date: Nov. 20, 2008

(54) CAMERA MODULE

(75) Inventor: WEN-QI LV, Foshan (CN)

Correspondence Address: PCE INDUSTRY, INC.;ATT. CHENG-JU CHIANG, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 11/875,147

(22) Filed: Oct. 19, 2007

(30) Foreign Application Priority Data
May 15, 2007 (CN) 200710200615.9

(51) Int. Cl. H04N 5/225

(52) U.S. Cl. 348/340; 348/E05.024

(57) ABSTRACT

A camera module includes a circuit board, an image sensor, a lens module, and a filter. The image sensor is mounted on the circuit board. The lens module is mounted on the circuit board and receives the image sensor therein. The lens module includes a barrel with at least one lens received therein and a holder. The holder defines a cavity. The cavity includes a first receiving portion, with the lens module received therein, and a second receiving portion, with the image sensor received therein. The filter covers an inner surface of the holder bounding the second receiving portion for trapping dust entered into the second receiving portion.

### TECHNICAL FIELD

The present invention relates to camera modules, and particularly to a dustproof camera module which can prevent dust from contaminating an optically sensitive area of an image sensor therein.

### DESCRIPTION OF RELATED ART

With the development of the optical imaging technology, camera modules are becoming widely used in electronic devices, such as digital cameras and mobile phones.

A camera module with an image sensor will often have problems caused by dust getting into the camera module. The dust may adhere to a surface of the image sensor or to a surface of some other optical component of the camera module, during or after the installation in a device, and cause artifacts to appear in any images produced thereafter.

Thus, assembling products in a clean room and various dust removal methods are employed to deal with the aforementioned problem. However, there may yet be some dust remaining in the camera module after assembly.

What is needed, therefore, is a dustproof camera module.

### SUMMARY

In accordance with one present embodiment, a camera module includes a circuit board, an image sensor, a lens module, and a filter. The image sensor is mounted on the circuit board. The lens module is mounted on the circuit board over the image sensor. The lens module includes a barrel with at least one lens received therein and a holder. The holder defines a cavity. The cavity includes a first receiving portion, with the barrel received therein, and a second receiving portion, with the image sensor received therein. The filter covers an inner surface of the holder around the second receiving portion.

### BRIEF DESCRIPTION OF THE DRAWING

Many aspects of the present camera module can be better understood with reference to the following drawings. The components in the drawing are not necessarily drawn to scale, the emphasis instead being placed upon clearly illustrating the principles of the present camera module. Moreover, in the drawing, like reference numerals designate corresponding parts throughout the several views.

FIG. 1 is a schematic, cross-sectional view of a camera module, according to a first embodiment;

FIG. 2 is a schematic, cross-sectional view of a camera module, according to a second embodiment;

FIG. 3 is a schematic, cross-sectional view of a camera module, according to a third embodiment; and

FIG. 4 is a schematic, cross-sectional view of a camera module, according to a fourth embodiment.

### DETAILED DESCRIPTION OF THE EMBODIMENTS

Embodiments will now be described in detail below, with reference to the drawings.

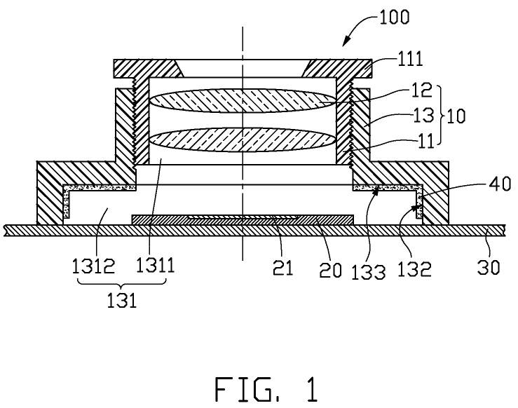

Referring to FIG. 1, a camera module 100, according to a first embodiment, is shown. The camera module 100 includes a lens module 10, an image sensor 20, a circuit board 30, and a filter 40. The image sensor 20 is mounted on the circuit board 30 and received between the lens module 10 and the circuit board 30.

The lens module 10 includes a barrel 11, at least one lens 12, and a holder 13. The barrel 11 is received at an end of the holder 13. The at least one lens 12 is received in the barrel 11. In the present embodiment, the lens module 10 has two lenses 12. It is understood that the number of the lens 12 can also be one, three, four and so on.

The barrel 11 is externally threaded. The material of the barrel 11 can, usefully, be selected from the group consisting of polycarbonate, acrylonitrile-butadiene-styrene, and any combinations thereof. The barrel 11 can, beneficially, also have a focus-adjusting ring 111 arranged at an end of the barrel away from the image sensor 20, in order to allow the focus of the camera module 100 to be conveniently adjusted. Advantageously, the focus-adjusting ring 111 is integrally formed with the barrel 11. Moreover, in order to improve light transmittance of the lens 12, the lens 12 can further have anti-reflection coatings on its two surfaces facing along the direction of an optical axis of the lens 12.

The holder 13 defines a cavity 131. The cavity 131 includes a first receiving portion 1311 and a second receiving portion 1312 communicating with the first receiving portion 1311. The first receiving portion 1311 is substantially cylindrical and is both shaped and sized (i.e., is, thus, properly structured/configured) for receiving the barrel 11. The inner surface of the holder 13 around the first receiving portion 1311 is internally threaded for engaging with the external thread of the barrel 11. Accordingly, the barrel 11 can be moved along a long/central axis of the cavity 131, in order to allow focus-adjustment of the camera module 100. The second receiving portion 1312 is approximately rectangular in cross-section.

The image sensor 20 is received in the second receiving portion 1312 and is optically aligned with the lens 12. The image sensor 20 is configured for electrically connecting to the circuit board 30 and can convert optical signals to digital image signals. The circuit board 30 can be a printed circuit board, such as a flexible printed circuit board. The image sensor 20 can, e.g., be a charge-coupled device (CCD) or a complementary metal oxide semiconductor device (CMOS). The image sensor 20 could further be selected from a ceramic leaded chip carrier (CLCC) package type image sensor, a plastic leaded chip carrier (PLCC) package type image sensor, or a chip scale package (CSP) type image sensor. The image sensor 20 has an optically sensitive area 21 on a surface facing the lens module 10.

The filter 40 is applied to prevent dust from migrating from the circuit board 30 along the inner surface of the holder 13 to eventually come to rest on the image sensor 20. It is known, that when dust migrates to a conventional holder, it usually travels up from a circuit board then rebounds off the inner surface of the conventional holder before alighting on an image sensor. To prevent this, in the present embodiment, the inner surface of the holder 13 around the second receiving portion 1312 is covered with the filter 40. The filter 40 traps any dust that would otherwise have bounced off the inner surface to land on the image sensor 20. The filter 40 can be a viscous material. Preferably, the viscous material is a double-sided tape. The inner surface of the holder 13 bounding the second receiving portion 1312 includes a lateral inner surface 132 and a top inner surface 133. The filter 40 is attached to the lateral inner surface 132 and the top inner surface 133.

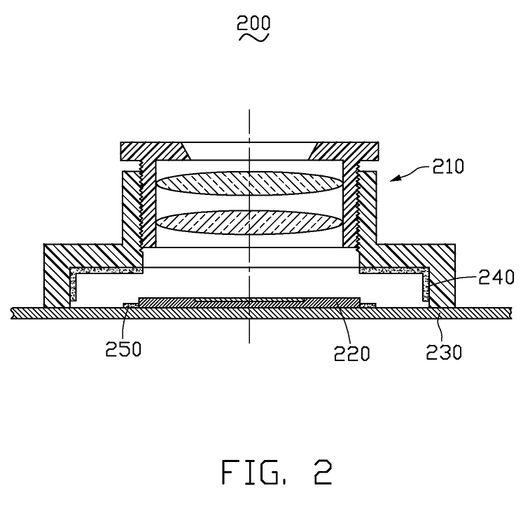

Referring to FIG. 2, a camera module 200 according to a second embodiment includes a lens module 210, an image sensor 220, a circuit board 230, and a filter 240. The image sensor 220 is mounted on the circuit board 230 and received between the lens module 210 and the circuit board 230. The camera module 200 is similar to the camera module 100 of the first embodiment. The difference between the camera module 200 and the camera module 100 is that the camera module 200 further includes a filter 250 disposed on the circuit board 230 around the image sensor 220. The filter 250 catches dust that would normally land on the circuit board 230 around the image sensor 220 and prevents it from migrating to the image sensor 220. The filter 250 can be made of same or different material as that of the filter 240 of a suitably viscous nature.

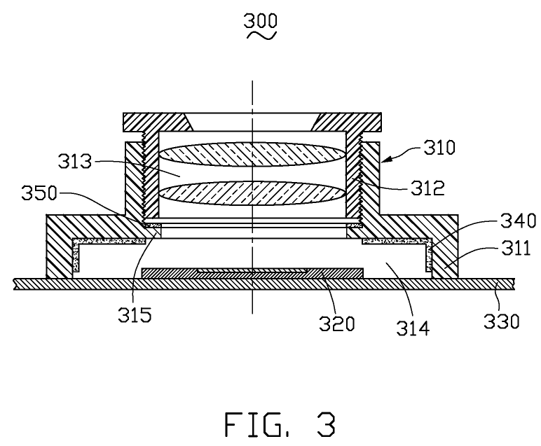

Referring to FIG. 3, a camera module 300 according to a third embodiment includes a lens module 310, an image sensor 320, a circuit board 330, and a filter 340. The image sensor 320 is mounted on the circuit board 330 and received between the lens module 310 and the circuit board 330. The lens module 310 includes a holder 311 and a barrel 312. The holder 311 defines a first receiving portion 313 configured for receiving the barrel 312 and a second receiving portion 314 configured for receiving the image sensor 320. The camera module 300 is similar to the camera module 100 of the first embodiment. The difference between the camera module 300 and the camera module 100 is that the holder 311 further includes a flange 315 extending in from an inner surface of the holder 311 around the first receiving portion 313. The flange 315 is at the image end of the barrel 312. A filter 350 covers the surface of the flange 315 facing the object side of the camera module 300. The filter 350 catches dust that may get in amongst the holder 311 and the barrel 312, and keep it from falling onto the image sensor 320. The filters 340, 350 can be made of same or different material of a suitably viscous nature.

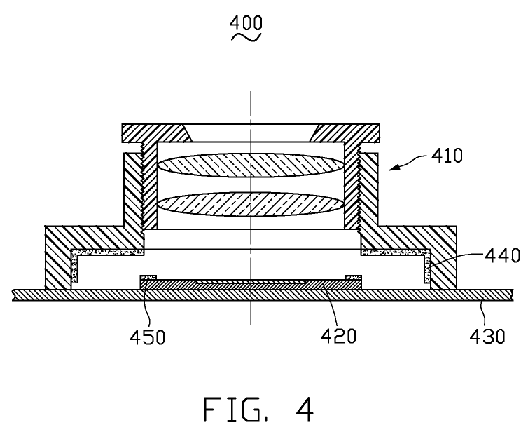

Referring to FIG. 4, a camera module 400 according to a fourth embodiment includes a lens module 410, an image sensor 420, a circuit board 430, and a filter 440. The image sensor 420 is mounted on the circuit board 430 and received between the lens module 410 and the circuit board 430. The camera module 400 is similar to the camera module 100 of the first embodiment. The image sensor 420 has an optically sensitive area on a surface thereof facing the lens module 410. The optically sensitive area is formed in the center of the surface. The difference between the camera module 400 and the camera module 100 is that the camera module 400 further includes a filter 450 disposed on the image sensor 220 around the optically sensitive area. The filter 450 should also be made of a suitably viscous material.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A camera module comprising:
a circuit board;
an image sensor mounted on the circuit board;
a lens module mounted on the circuit board and receiving the image sensor therein, the lens module comprising:
a barrel with at least one lens received therein;
a holder defining a cavity, the cavity including a first receiving portion with the barrel received therein and a second receiving portion with the image sensor received therein; and
a filter covering an inner surface of the holder bounding the second receiving portion configured to trap dust entered into the second receiving portion.

2. The camera module as claimed in claim 1, wherein the filter covers a lateral inner surface of the holder around the second receiving portion.

3. The camera module as claimed in claim 1, wherein the filter covers an inner surface of the holder at the top of the receiving portion.

4. The camera module as claimed in claim 1, further comprising another filter disposed on the circuit board around the image sensor.

5. The camera module as claimed in claim 4, wherein the another filter disposed on the circuit board around the image sensor is made of a material same or different with that of the filter covering the inner surface of the holder.

6. The camera module as claimed in claim 1, wherein the holder has a flange extended from an inner surface of the holder around the first receiving portion near the second receiving portion, the camera module further includes another filter disposed on a surface of the flange facing the object side of the camera module.

7. The camera module as claimed in claim 6, wherein the filter disposed on the surface of the flange is made of a material same or different with that of the filter covering the inner surface of the holder.

8. The camera module as claimed in claim 1, wherein the image sensor has an optically sensitive area on a surface of the image sensor facing the lens module, the camera module further includes another filter disposed on the image sensor around the optically sensitive area.

9. The camera module as claimed in claim 8, wherein the filter disposed on the image sensor around the optically sensitive area is made of a material same or different with that of the filter covering the inner surface of the holder.

10. The camera module as claimed in claim 1, wherein the filter is made of a viscous material.

11. The camera module as claimed in claim 10, wherein the viscous material is double-sided tape.

12. The camera module as claimed in claim 1, wherein the material of the barrel is selected from the group consisting of polycarbonate, acrylonitrile-butadiene-styrene, and any combinations thereof.

13. The camera module as claimed in claim 1, wherein the barrel has a focus-adjusting ring arranged at an end of the barrel away from the image sensor.

14. The camera module as claimed in claim 13, wherein the focus-adjusting ring is integrally formed with the barrel.

15. The camera module as claimed in claim 1, wherein the circuit board is a printed circuit board.

16. The camera module as claimed in claim 1, wherein the image sensor is a charge-coupled device or a complementary metal oxide semiconductor device.

17. The camera module as claimed in claim 1, wherein the image sensor is selected from a group consisting of a ceramic leaded chip carrier package type image sensor, a plastic leaded chip carrier package type image sensor, and a chip scale package type image sensor.

18. A camera module comprising:
a circuit board;
a holder attached to the circuit board, the holder defining a cavity comprising a first receiving portion and a second receiving portion;
an image sensor received in the second receiving portion and mounted on the circuit board;
a barrel with at least one lens received therein being received in the first receiving portion and aligned with the image sensor; and
a filter attached to an inner surface of the holder bounding the second receiving portion, the filter being made of a material which is capable of trapping dust entered into the second receiving portion.

19. The camera module as claimed in claim 18, wherein the filter is made of a viscous material such that the filter is capable of absorbing the dust entered into the second receiving portion.

20. The camera module as claimed in claim 18, wherein the filter is made of a double-sided tape such that the filter is capable of adhering to the inner surface of the holder and absorbing the dust entered into the second receiving portion.
